(19) United States
(12) Patent Application Publication
(10) Pub. No.: US 2010/0039550 A1
(43) Pub. Date: Feb. 18, 2010

(54) Bearing Assembly for Use in a Gimbal Servo System

(75) Inventor: Edward Bruce Baker, Longwood, FL (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: DRS Sensors & Targeting Systems, Inc., Dallas, TX (US)

(21) Appl. No.: 11/938,053

(22) Filed: Nov. 9, 2007

Related U.S. Application Data
(60) Provisional application No. 60/865,321, filed on Nov. 10, 2006.

(51) Int. Cl. H04N 5/232

(52) U.S. Cl. 348/357; 348/E05.042

(57) ABSTRACT

A bearing assembly suitable for use in a gimbal servo system is provided. The bearing assembly comprises a shaft having an end adapted to be coupled to a payload, a sleeve disposed over the shaft, an inner bearing rotatingly coupled to the shaft and the sleeve, an outer housing disposed over the sleeve, an outer bearing rotatingly coupled to the sleeve and the outer housing such that the sleeve is adapted to rotate about the shaft relative to the housing, a first motor operatively configured to rotate the shaft relative to the outer housing, and a second motor operatively configured to rotate the sleeve about the shaft. The second motor rotates the sleeve in a predetermined direction at a predetermined velocity such that a sum of the predetermined velocity and a velocity associated with inner bearing friction remains positive regardless of the direction of the shaft rotation.

### CROSS-REFERENCE TO RELATED APPLICATIONS

This application claims the benefit of the filing date of U.S. Provisional Application No. 60/865,321, entitled “Frictionless Bearing For Use In Servo Systems,” filed on Nov. 10, 2006, all of which are incorporated herein by reference.

### BACKGROUND OF THE INVENTION

The present invention relates to gimbal servo systems used to stabilize one or more axis of a gimballed platform. More particularly, the present invention relates to a bearing assembly for use in a gimbal servo system, where friction associated with a gimbal bearing of the bearing assembly is effectively suppressed.

Gimbal servomechanisms or servo systems are typically used to stabilize gimballed platforms for optical systems (“gimballed optical systems”), such as TV cameras and infrared (IR) cameras on aircraft and ground vehicles, in order to minimize the movement of the line of sight (LOS) of the respective optical system. Conventional gimbal servomechanisms typically employ a rate sensor (such as a gyroscope) mounted on the gimballed platform to sense movement (e.g., angular velocity) about one or more gimballed axis of the platform. A servo or torquer motor of the gimbal servomechanism is used to counter rotate the platform about the respective gimballed axis to compensate for the sensed movement and stabilize the gimballed platform and, thus, the line of sight (LOS) of the optical system mounted on the gimballed platform. However, conventional gimbal bearing assemblies used in gimballed optical systems typically impart a gimbal bearing friction disturbance when the mounting base of the gimballed platform moves about the gimbal axis containing the gimbal bearing. The gimbal bearing friction causes a torque disturbance into the conventional servomechanism or servo system which, in response, produces a jitter or unwanted movement of the LOS of the optical system that may adversely affect the resolution of the gimballed optical system.

Certain conventional gimbal servomechanisms have employed various designs to correct for gimbal bearing friction disturbances to stabilize the line of sight (LOS) of the optical systems to an acceptable LOS stabilization error level. However, the level of the LOS stabilization error for gimballed optical systems is still problematic, especially for optical systems that employ a long focal length camera to, for example, identify and track targets.

In addition, certain conventional servo stabilized gimballed platforms (such as disclosed in Bowditch et al., U.S. Pat. No. 4,395,922) attempt to eliminate gimbal bearing friction by adding more gimbals and using flex pivots with the additional gimbals. Such a solution to the problem of gimbal bearing friction disturbances adds unnecessary complexity and cost to the gimballed system.

FIG. 1 depicts, in cross-sectional view, a conventional bearing assembly and gimbal servo system 10 for stabilizing a single axis 12 (e.g., azimuth axis) of a gimballed platform or payload 14. FIG. 2 is a functional block diagram of the conventional gimbal servo system 30 in FIG. 1. As shown in FIG. 1, the conventional bearing assembly includes a single bearing 16 and seal 18 arrangement. The single bearing 16 rotatingly couples a gimbal axle or shaft 20 attached to the payload 14 along the axis 12 to a housing or support structure 22 so that a servo or torquer motor 23 (a component of the gimbal servo system depicted in functional form in FIG. 2) may rotate the payload 14 to counter movement of the payload about the axis 12 that is sensed by a rate sensor 24 mounted on the payload 14 to sense the angular rate or velocity about the axis 12. The torquer motor 23 is typically implemented via a rotor 26 affixed to shaft 20 and a stator 28 affixed to the support structure 22.

Two additional bearing assemblies and gimbal servo systems 10 (not shown in FIG. 1) are usually employed to stabilize each gimbal axis (e.g., pitch axis and roll axis) of a gimballed platform or payload. Thus, a conventional gimballed platform or payload having three axis of movement typically has a single bearing 16 for each of the three axis.

The bearing 16 typically imparts a friction disturbance in the direction of movement of the payload 14 about the axis 12 of the gimbal shaft 20. The friction disturbance abruptly changes sign (or direction or polarity) when the relative velocity between the shaft 20 and the housing or support structure 22 (e.g., corresponding to payload 14 velocity about the axis 12) changes sign (or direction or polarity). The friction torque change (corresponding to change in sign of the friction disturbance) typically occurs so abruptly that the gimbal servomechanism or system cannot compensate for it quickly enough. As a result, the gimbal or shaft 20 moves before the servomechanism can stop it due to the limited bandwidth and finite response time of the servomechanism, which results in jitter movement about the axis 12. Since the gimbal bearing friction disturbance is usually non-linear and not entirely predictable, conventional gimbal servomechanisms or systems fail to accurately compensate for the friction.

The conventional gimbal servo system 30 for each gimbal axis typically includes a servo controller (not shown in FIG. 1) that includes a summer 32 that is operatively configured to output a velocity difference between a rate command signal 34 (usually supplied by a vehicle system controller not shown in the figures) and the angular velocity sensed by the rate sensor 24. The servo controller also typically includes a compensator 36 operatively configured to receive the velocity difference output from the summer 32 and output a compensation rate signal that is adjusted by a rate loop gain controller and then amplified by a power amplifier 40. The amplified compensation rate signal 42 output from the power amplifier is received by the torquer motor 23, which supplies a counter rotation torque 44 that is adjusted (as modeled by the summer 46) by friction disturbance 48 of the bearing 16 (which has a sign corresponding to the direction of movement of the payload 14 about the shaft 20). The adjusted counter rotation torque 50 when applied to the gimbal shaft 20 is effectively multiplied by the reciprocal of the known gimbal inertia (1/J_{G}) corresponding to the gimbal shaft 20 (as modeled by the multiplier 52). The resulting gimbal 20 acceleration 54 is effectively integrated (as modeled by the integrator 56) to produce the angular velocity 58 of the platform 14 that is sensed by the rate sensor 24 and induces the friction disturbance 48 of the bearing 16 in the same direction as the angular velocity 58.

As shown in FIG. 2, the compensator 32 is typically a proportional plus integral (PI) compensator with a break frequency (ω_{z}) set to maximize the low frequency gain of the gimbal servo system 30 while still maintaining a sufficient phase margin at the zero dB crossover frequency of the counter rotation torque 44 output of the torquer motor 23. The zero dB crossover frequency is typically between 25 and 60 Hz. The compensator 32 typically has an infinite static gain due to the integrator 56. However, due to the limited gain of the servo system 30 at the frequencies of the friction disturbance 48 torque, the payload 14 (and the LOS of the optical system comprising the payload) jitters as a result of the friction disturbance 48. Increasing the zero dB crossover frequency of the servo system 30 and thereby increasing the open loop gain of the servo system 30 may reduce the effect of the friction disturbance 48. However, due to limitations in the servo system 30, such as limited bandwidth of the rate sensor 24 or structural resonances, it is usually not possible to reduce the effects of the bearing friction disturbance 48 to a sufficiently low level.

FIGS. 3A-3D show the effect of angular motion of the support structure 22 inducing the friction disturbance 48 of the bearing 16 and causing jitter of the gimballed platform or payload line of sight (LOS). FIG. 3A is an exemplary graph depicting the angular position of the support structure 22 of the conventional bearing assembly shown in FIG. 1 relative to the gimbal (i.e., shaft 20) over time. FIG. 3B is an exemplary graph of the angular velocity of the support structure 22 relative to the gimbal 20 over time, where the angular velocity corresponds to the angular position shown in FIG. 3A. FIG. 3C is an exemplary graph of the friction torque of the bearing 16 coupling the support structure 22 to the gimbal 20 of the conventional bearing assembly, where the bearing friction torque is generated based on the angular velocity of the support structure shown in FIG. 3B. FIG. 3D is an exemplary graph of the LOS jitter of the gimballed platform or payload 14 caused by the bearing 16 friction torque shown in FIG. 3C. For a typical two axis gimbal with bearings 16 and seals 18 and a 40-50 Hz zero dB crossover frequency on the servo system 30, the LOS jitter (as reflected in FIG. 3D) due to bearing friction disturbance 48 is 200-300 micro radians peak to peak. Thus, bearing friction disturbances remain problematic for gimballed optical systems in which image resolution is impacted by a LOS jitter of 200-300 micro radians peak to peak.

There is therefore a need for a bearing assembly that overcomes the problems noted above and enables the realization of gimbal servo system in which a bearing friction disturbance is effectively negated to avoid jitter of the gimballed platform or payload.

### SUMMARY OF THE INVENTION

Systems, apparatuses, and articles of manufacture consistent with the present invention provide a means for use in a gimbal servo system to compensate for or eliminate a friction disturbance imparted on a gimbal by a bearing (“bearing friction”) to effectively prevent jitter of the gimballed platform or payload stabilized by the gimbal servo system.

In accordance with systems and apparatuses consistent with the present invention, a bearing assembly suitable for use in a gimbal servo system is provided. The bearing assembly comprises a shaft having an end adapted to be coupled to a payload, a sleeve disposed over the shaft, an inner bearing rotatingly coupled to the shaft and to the sleeve such that the sleeve is adapted to rotate about the shaft; an outer housing disposed over the sleeve, and an outer bearing rotatingly coupled to the sleeve and the outer housing such that the sleeve is adapted to rotate about the shaft relative to the housing. The bearing assembly further includes a first motor operatively configured to rotate the shaft relative to the outer housing and a second motor operatively configured to rotate the sleeve about the shaft.

In one implementation of the bearing assembly, the second motor rotates the sleeve in a predetermined direction at a predetermined velocity having a sign corresponding to the predetermined direction. In this implementation, the inner bearing imparts a friction disturbance on the shaft when the shaft is rotated. The friction disturbance corresponds to a bearing velocity having a sign corresponding to a direction of shaft rotation. The predetermined velocity of the sleeve is set such that a sum of the predetermined velocity and the bearing velocity remains positive regardless of the direction of the shaft rotation.

Since the sum of the velocities of the bearings (and, thus, the total bearing friction) never changes sign (or direction or polarity), the gimbal servo system that stabilizes the shaft or gimbal is able to easily compensate for the friction torque associated with both the inner and outer bearings as the torque is nearly constant (or at worst has some low frequency cyclical variation) and never changes sign (or direction or polarity). A gimbal servo system that utilizes a bearing assembly implemented in accordance with the present invention typically has an infinite static gain. Thus, the friction torque associated with both the inner and outer bearings of the bearing assembly causes a slight or no offset so that the first motor torque is able to balance the friction torque.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 shows a cross-sectional view of a conventional bearing assembly and servo system for stabilizing a single axis of a gimballed platform or payload;

FIG. 2 is a functional block diagram of the gimbal servo system in FIG. 1;

FIG. 3A is a graph of the angular position of a support structure of the conventional bearing assembly in FIG. 1 relative to the single axis gimbal versus time;

FIG. 3B is a graph of the angular velocity of the support structure of the conventional bearing assembly relative to the single axis gimbal versus time, where the angular velocity corresponds to the angular position shown in FIG. 3A;

FIG. 3C is a graph of the friction torque of a bearing coupling the support structure to the gimbal of the conventional bearing assembly, where the bearing friction torque is generated based on the angular velocity shown in FIG. 3B of the support structure;

FIG. 3D is a graph of the gimballed platform or payload LOS jitter caused by the bearing friction torque shown in FIG. 3C;

FIG. 4 shows a cross-sectional perspective view of a bearing assembly consistent with the present invention;

FIG. 5 is a functional block diagram of an exemplary gimbal servo system for a gimbal implemented in accordance with the present invention, using the bearing assembly depicted in FIG. 4;

FIG. 6A is a time history graph of the angular position of a housing for the bearing assembly in FIG. 4 relative to a gimbal axis;

FIG. 6B is a time history graph of the angular velocity of the bearing assembly housing relative to the gimbal axis, where the angular velocity corresponds to the angular position shown in FIG. 6A;

FIG. 6C is a time history graph of the angular velocity of an inner sleeve or middle race member of the bearing assembly relative to the angular velocity of the housing shown in FIG. 6B;

FIG. 6D is a time history graph of the angular velocity of an inner sleeve or middle race member of the bearing assembly relative to a shaft of the bearing assembly, where the shaft represents a gimbal for a platform supported on the shaft, an inner race member of an inner bearing is attached to the shaft, and the shaft is stationary;

FIG. 6E is a time history graph of the friction disturbance or torque of the inner bearing imparted on the shaft;

FIG. 6F is a time history graph of the movement of the LOS of the gimballed platform or payload caused by the inner bearing friction disturbance or torque shown in FIG. 6E; and

FIG. 7 is an alternative functional block diagram of the exemplary gimbal servo system shown in FIG. 5, where the effect of the middle race member velocity on the inner bearing friction disturbance is illustrated via a combined friction disturbance that does not change direction relative to the velocity of the shaft or gimbal.

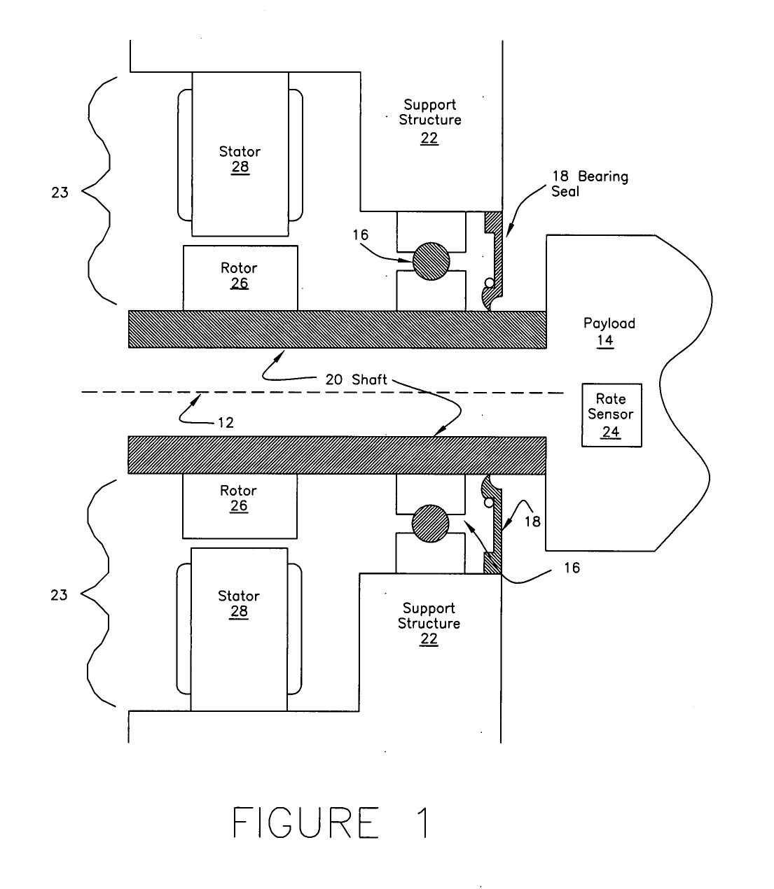

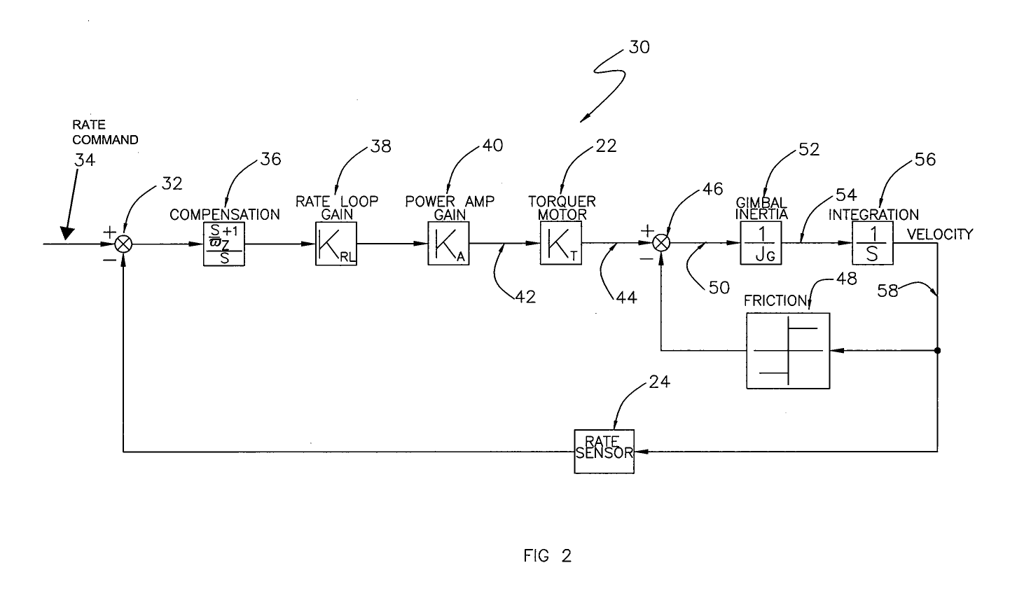

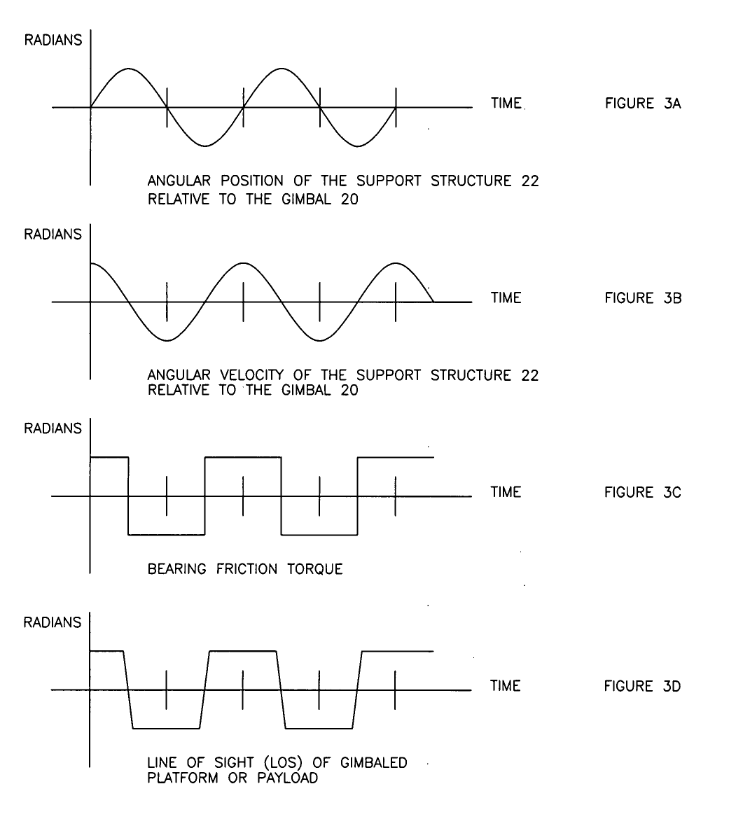

### DETAILED DESCRIPTION OF THE INVENTION

Reference will now be made in detail to an implementation in accordance with methods, systems, and products consistent with the present invention as illustrated in the accompanying drawings.

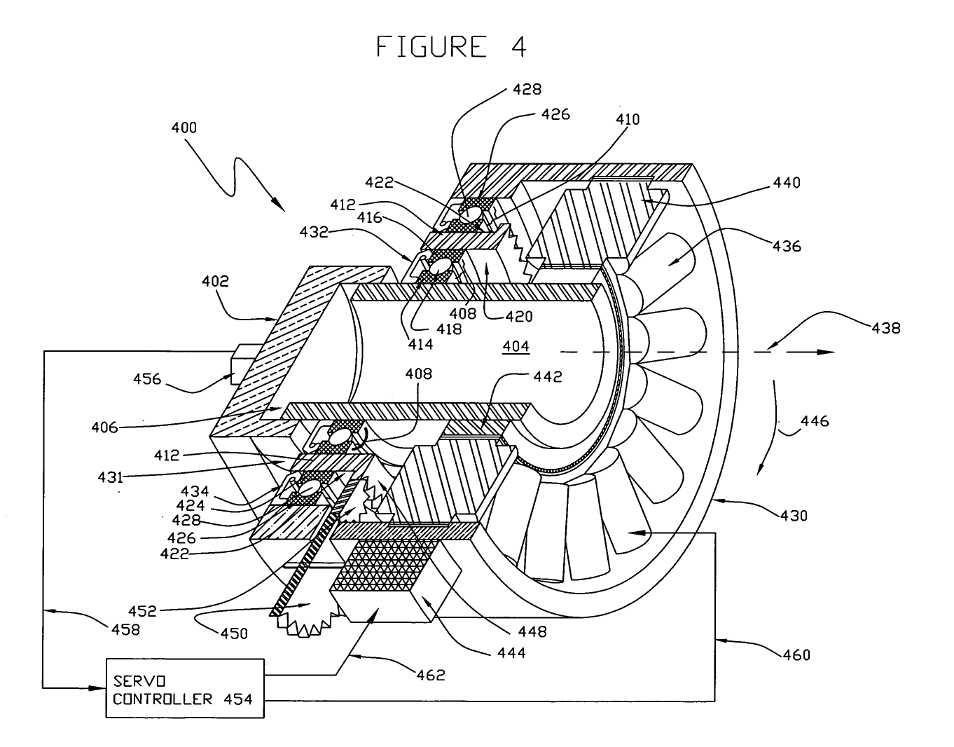

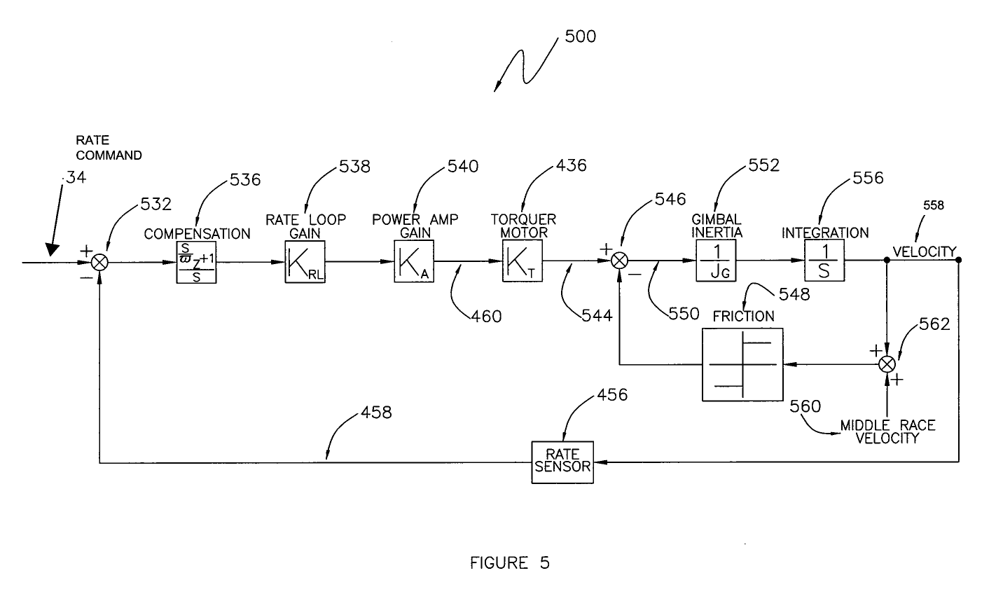

FIG. 4 shows a cross-sectional perspective view of a bearing assembly 400 consistent with the present invention. The bearing assembly 400 may be used in a gimbal servo system (such as the gimbal servo system 500 depicted in FIG. 5) to stabilize a gimballed platform or payload 402 as discussed in further detail below. The bearing assembly 400 includes a shaft 404 having an end 406 adapted to be coupled to the platform or payload 402. The bearing assembly 400 further includes an inner bearing 408, an outer bearing 410, and a sleeve 412 disposed over the shaft 404 between the inner bearing 408 and the outer bearing 410.

The inner bearing 408 has an inner race member 414, an outer race member 416 and a ball or roller bearing 418 disposed between the inner race member 414 and the outer race member 416. In an alternative implementation, the ball or roller bearing 418 may be replaced with another element or material that enables the inner race member 414 and the outer race member 416 to travel relative to each other in the same or opposite directions. For example, the ball or roller bearing 418 may be replaced with a needle bearing or a journal bearing or any combination of roller bearings, ball bearings, needle bearings or journal bearings.

The inner race member 414 is coupled or affixed to the shaft 404 such that the inner bearing 408 is rotatingly coupled to the shaft 404 as the inner race member 412 travels via the ball or roller bearing 418. In the implementation shown in FIG. 4, the inner race member 414 extends the circumference of the shaft 404.

The sleeve 412 has an inner surface 420 and an outer surface 422. The outer race member 416 of the inner bearing 408 is coupled or affixed to the inner surface 420 of the sleeve 412. Thus, the inner bearing 408 is rotatingly coupled to the shaft 404 and to the sleeve 412 via the ball or roller bearing 418 such that the sleeve 412 is adapted to rotate about the shaft 404.

As shown in FIG. 4, the outer bearing 410 has an internal race member 424, an external race member 426, and a ball or roller bearing 428 disposed between the internal race member 424 and the external race member 426. In an alternative implementation, the ball or roller bearing 428 may be replaced with another element or material (e.g., a needle bearing or a journal bearing or any combination of roller bearings, ball bearings, needle bearings or journal bearings) that enables the internal race member 424 and the external race member 426 to travel relative to each other in the same or opposite directions. The internal race member 424 of the outer bearing 410 is coupled or affixed to the outer surface 422 of the sleeve 412 such that the outer bearing 410 is rotatingly coupled to the sleeve 412 as the internal race member 424 travels via the ball or roller bearing 428.

An outer housing 430 is disposed over the sleeve 412 and coupled to the external race member 426 of the outer bearing 410. Thus, the outer bearing 410 is rotatingly coupled to the sleeve 412 and the outer housing 430 via the ball or roller bearing 428 such that the sleeve 412 is adapted to rotate about the shaft 404 relative to the housing 430.

The outer race member 416 of the inner bearing 408, the internal race member 424 of the outer bearing 410, and the sleeve 412 collectively define a middle race member 431. In accordance with the present invention as discussed in further detail below, the middle race member 431 is rotated at a constant velocity in a predetermined direction about the gimbal shaft 404 so that the friction disturbance of the inner bearing 408 (which is imparted on the gimbal shaft 404) is effectively suppressed and the gimbal servo system 500 is prevented from generating LOS jitter due to the bearing friction disturbance.

Returning to FIG. 4, the bearing assembly 400 may also include a first seal 432 for protecting the inner bearing 408 and a second seal 434 for protecting the outer bearing 410 from contaminants external to the housing 430. Both seal 432 and seal 434 may have one end with a sealing lip that rubs on the sleeve 412 when the sleeve is rotated about the shaft 404. In this implementation, seal 432 has another end attached to the shaft 404 or the inner race member 414 of the inner bearing 408. The seal 434 also has another end attached to the housing 430 or the external race member 426. Alternatively, the seals 432 and 434 may be reversed so that both seals 432 and 434 have an end attached to the sleeve 412. In this implementation, the sealing lip of the seal 432 rubs on the shaft 404 and the sealing lip of the seal 434 rubs on the housing 430. Where reference is made to bearing friction or bearing friction disturbance, the bearing friction or bearing friction disturbance also includes the sealing lip rubbing or friction of the respective seal 432 or 434.

As shown in FIG. 4, the bearing assembly 400 may also include a first motor 436 that is operatively configured to rotate or drive the shaft 404 about a central axis 438 of the shaft 404 and relative to the outer housing 430. In one implementation, the first motor 436 is a servo or torquer motor having a stator 440 attached to the housing 430 and a rotor 442 attached to the shaft 404 so that the payload 402 may be torqued about the gimbal or shaft 404 by supplying current to the first or torquer motor 436.

The bearing assembly 400 may further include a second motor 444 operatively configured to rotate the sleeve 412 or the middle race member 431 about the gimbal shaft 404. The second motor 444 rotates the sleeve 412 or the middle race member 431 in a predetermined direction (e.g., as referenced by arrow 446 in FIG. 4) at a predetermined velocity having a sign corresponding to the predetermined direction 446. When the gimbal shaft 404 is torqued or rotated, the inner bearing 408 imparts a friction disturbance (referenced as 548 in FIG. 5) on the shaft 404. The friction disturbance 548 corresponds to a bearing velocity having a sign corresponding to a direction of shaft rotation, which may be the same as or opposite to the predetermined direction 446 of the sleeve 412 or middle race member 431. The predetermined velocity of the sleeve 412 is set and held constant by the second motor 444 such that a sum of the predetermined velocity of the sleeve 412 or the middle race member 431 and the velocity of the inner bearing 408 remains positive regardless of the direction of the rotation of the shaft 404. Since the collective friction disturbance 548 associated with the inner bearing 408 and outer bearing 410 remains positive, no abrupt change in velocity direction associated with the bearing friction disturbance is observed by the gimbal servo system 500. As a result, by implementing the present invention, LOS jitter due to bearing friction disturbance is prevented from occurring (and effectively eliminated) where the gimbal servo system is too slow to respond and eliminate the abrupt change in bearing friction disturbance.

The second motor 444 may be an electric motor having a torque capacity sufficient to rotate the sleeve 412 or the middle race member 431 at a constant velocity that is greater than the maximum velocity of the inner bearing's 408 friction disturbance. Accordingly, the second motor 444 may be operated at any velocity or speed as long as the speed is high enough so that the relative velocity of the inner race member 414 of the inner bearing 408 to the middle race member 431 does not cross through zero (e.g., the velocity corresponding to the combined inner bearing friction disturbance and the middle race member remains positive or negative).

In one implementation in which the friction disturbance of the inner bearing 408 corresponds to a low level velocity having a sign consistent with the direction of the gimbal or shaft 404 rotation (e.g., an inner bearing velocity within the range of +/−2 radians/sec), the predetermined velocity of the sleeve 412 or middle race member 431 is set or maintained by the second motor 444 such that the sum of the predetermined velocity and the inner bearing velocity (corresponding to the inner bearing friction disturbance) is within the range of 0 to 7 radians per second.

In the implementation shown in FIG. 4, the second motor 444 is configured to rotate the sleeve 412 or the middle race member 431 in a clockwise direction 446 while the first motor 436 is operating and inner bearing friction imparted on the gimbal shaft 404. However, the second motor 444 may be configured to rotate the sleeve 412 or the middle race member 431 at a predetermined velocity in a counter-clockwise direction while the first motor 436 is operating,

In one implementation, the second motor 444 may be a gear motor attached to an exterior or interior surface of the housing 430. In this implementation, a ring gear 448 may be operatively coupled to the sleeve 412 such that the sleeve 412 rotates in accordance with rotation of the ring gear 446, which is driven by the second motor 444. A spur gear 450 may operatively couple the ring gear 448 to the second or gear motor 444. In the implementation shown in FIG. 4, the spur gear 450 turns an idler gear 452 that in turn turns the ring gear 448 in a direction opposite to the direction of rotation of the spur gear 450.

The bearing assembly 400 (when used in a gimbal servo system 500 as shown in FIG. 5 for stabilizing the gimbal corresponding to shaft 404) may also include a servo controller 454 and a rate sensor 456 (such as a gyroscope) mounted on or in the platform or payload 402 to sense movement (e.g., angular velocity) about the gimballed axis 438 of the platform (i.e., about the gimbal corresponding to the shaft 404). The rate sensor 456 is adapted to output a gimbal velocity signal 458 representing the sensed movement to the servo controller 454. As part of the gimbal servo system 500, the servo controller 454 is adapted to output a compensation rate signal 460 to the servo or torquer motor 436 to counter the rotation of the shaft 404 as reflected by the gimbal velocity signal 458. In the implementation shown in FIG. 4, the servo controller 454 may also be operatively configured to output a trigger signal 462 to signal that the first motor 436 is operating and to prompt the second motor 444 to rotate the sleeve 412 or middle race member 431 to suppress the generation of jitter due to inner bearing friction disturbance in accordance with the present invention.

In an alternative implementation, the rate sensor 456 may be a tachometer generator, incremental encoder, or other velocity sensor disposed between the shaft 412 and the housing 430. In yet another implementation, the rate sensor 456 may be implemented using a position transducer such as a potentiometer, resolver, encoder, or inductosyn mounted between the shaft 412 and the housing 430.

As shown in FIG. 5, the gimbal servo system 500 may have components similar to the conventional servo system 30. However, by employing the outer bearing 410 and the rotating sleeve 412 or middle race member 431, the gimbal servo system 500 is effectively adapted to counter inner bearing friction disturbance imparted on the gimbal or shaft 404 with the uni-directional velocity of the sleeve or middle race member, where the velocity of the sleeve or middle race member has a magnitude that is greater than the velocity corresponding to the inner bearing friction disturbance.

For example, in the implementation shown in FIG. 5, the servo controller 454 of the gimbal servo system 500 includes a summer 532 that is operatively configured to output a velocity difference between a rate command signal 34 (which may be supplied by a vehicle system controller not shown in the figures) and the angular velocity signal 458 output by the rate sensor 456 to reflect the sensed movement (i.e., gimbal velocity 558 in FIG. 5) of the gimballed platform or payload 402 about the gimbal or shaft 404. The servo controller 454 also may include a compensator 536, a rate loop gain controller 538, and a power amplifier 540. The compensator 536 is operatively configured to receive the velocity difference output from the summer 532 and output a compensation rate signal that is adjusted by the rate loop gain controller 538 and then amplified by the power amplifier 40. The amplified compensation rate signal 460 output from the power amplifier is received by the torquer motor 436, which supplies a counter rotation torque 544 that is adjusted (as modeled by the summer 546) by the velocity of the friction disturbance 548 associated with the inner bearing 408 as offset by the velocity 560 of the sleeve 412 or the middle race member 560. The inner bearing friction disturbance 548 is offset by the velocity 560 of the sleeve 412 or the middle race member 431 velocity so that the bearing disturbance 548 is inhibited from changing sign and so the direction of bearing friction torque remains constant.

The adjusted counter rotation torque 550 when applied to the gimbal shaft 404 is effectively multiplied by the reciprocal of the known gimbal inertia (1/J_{G}) corresponding to the gimbal shaft 404 (as modeled by the multiplier 552). The resulting gimbal acceleration 554 is effectively integrated (as modeled by the integrator 556) to produce the angular velocity 558 (or “gimbal velocity”) of the platform 402 that is sensed by the rate sensor 24. However, as previously discussed, the friction disturbance of the inner bearing 408 imparted on the gimbal shaft 404 (in the same direction as the gimbal velocity 558 is effectively offset (as modeled by the summer 560) by the velocity 560 of the sleeve or middle race member 431. As a result, the bearing friction disturbance 548 in the gimbal servo system 500 does not abruptly change direction and remains positive, preventing jittering of the gimballed platform or payload 402.

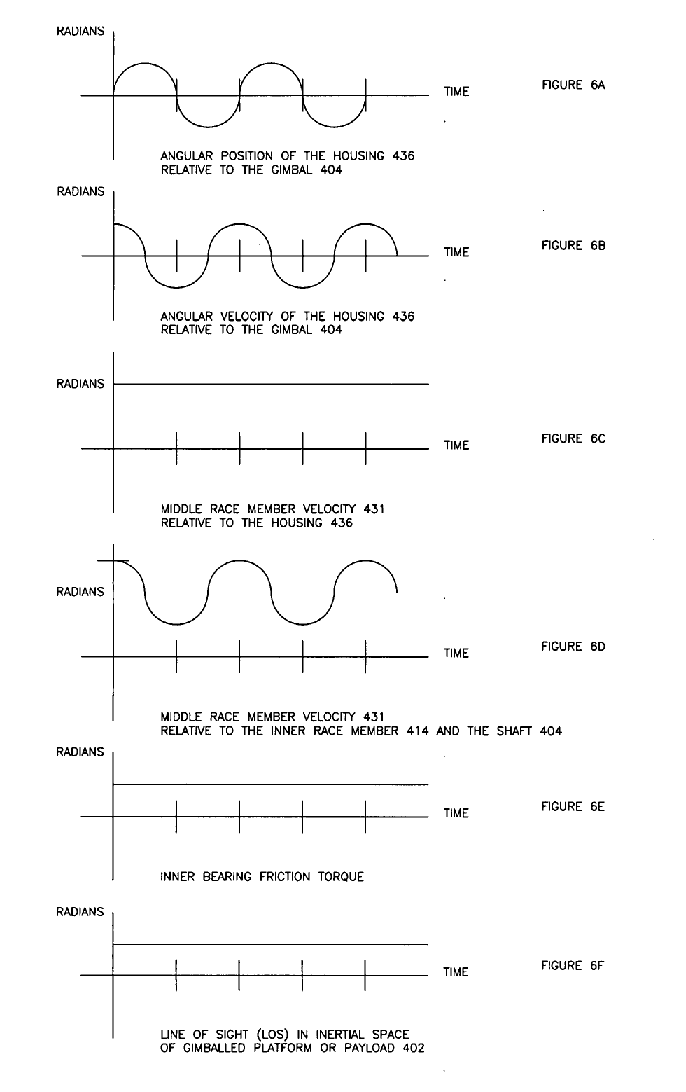

FIGS. 6A-6F illustrate the effect of the outer bearing 410 and the middle race member velocity 560 on the friction disturbance of the inner bearing and on the subsequent stabilization by the gimbal servo system 500 of the gimbal or shaft 404. FIG. 6A depicts an exemplary time history graph of the angular position of the housing 436 or support structure of the bearing assembly relative to the gimbal axis 438 and the shaft 404. FIG. 6B is a time history graph of the angular velocity of the bearing assembly housing 436 or support structure relative to the gimbal axis 438 and the shaft 404. In this example, the angular velocity corresponds to the angular position of the housing 436 shown in FIG. 6A. The angular velocity or motion of the bearing assembly housing 436, although shown as a sine wave in FIG. 6A, is arbitrary. The motion is caused by movements of the vehicle (e.g., airplane, tank, truck or other vehicle) or other structure or device to which the housing 436 is mounted. The relative motion of the housing 436 to the inner shaft 404 (and not the absolute or inertial motion of either the housing or shaft, individually) is typically the key movement sensed and compensated by the gimbal servo system 500 for stabilizing the gimballed platform or payload. In the exemplary implementation depicted in FIGS. 6A-6F, the shaft is stationary or stabilized and the housing 435 is moving. FIG. 6C is an exemplary time history graph of the angular velocity of the sleeve 412 or middle race member 431 of the bearing assembly 400 relative to the angular velocity of the housing shown in FIG. 6B. FIG. 6D is an exemplary time history graph of the angular velocity of the sleeve 412 or the middle race member 431 of the bearing assembly 400 relative to the shaft 404 and the inner race member 414 of the inner bearing 408. As previously discussed, the shaft 404 represents an azimuth gimbal for the platform or payload 402 supported on the shaft 404. As previously noted, the shaft 404 is stationary due to stabilization of the shaft 404 by the gimbal servo system 500. Note that the velocity of the sleeve 412 and the middle race member 431 as driven by the second motor 444 does not change sign. FIG. 6E is a time history graph of the friction disturbance or torque of the inner bearing 408 imparted on the shaft 404 (as measured at the shaft 404). Note that the inner bearing friction disturbance or torque is constant and, thus, is inhibited from causing jitter of the platform or payload. FIG. 6F is a time history graph of the movement of the LOS of the gimballed platform or payload caused by the inner bearing friction disturbance or torque shown in FIG. 6E. The slight offset of the LOS shown in FIG. 6E cannot be measured or is negligible in most optical applications or systems mounted on a gimballed platform and employing the bearing assembly 400 in accordance with the present invention. However, the gimbal servo system 500 using the bearing assembly 400 may be modified to cause the LOS offset reflected in FIG. 6E to be zero by employing another compensator between the first compensator 536 and the rate loop gain controller 538, where the other compensator is configured to suppress or zero out the LOS offset.

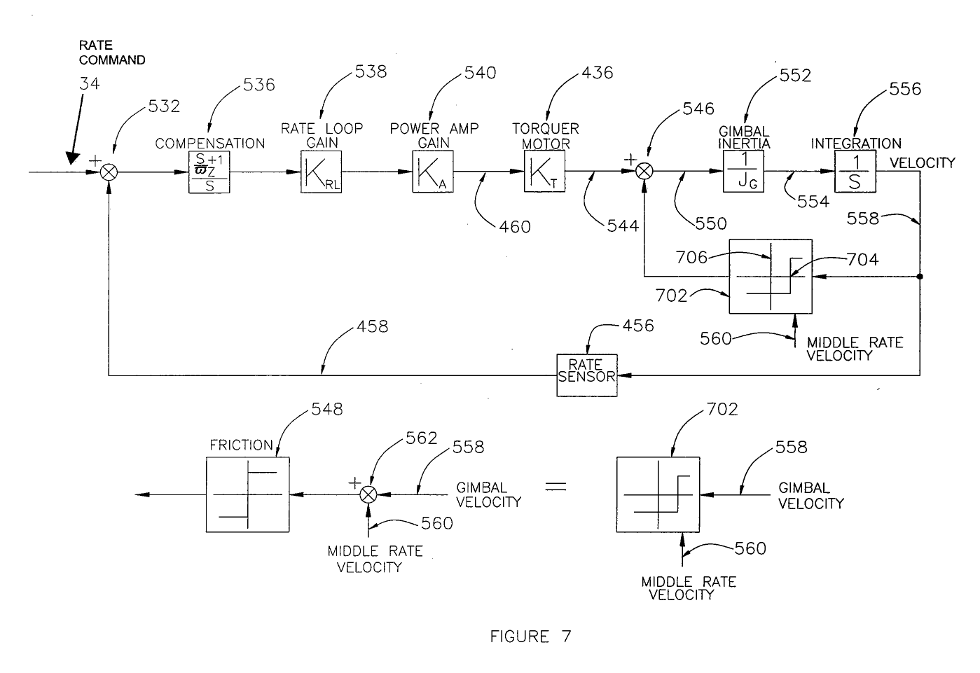

FIG. 7 is an alternative functional block diagram of the exemplary gimbal servo system shown in FIG. 5, where the effect of the velocity of the sleeve 412 or middle race member 431 on the inner bearing friction disturbance is illustrated via a combined friction disturbance 702 that represents the sum of the friction disturbance of the inner bearing 408 and the uni-directional velocity 560 of the sleeve 412 or middle race member 431. As previously noted, the combined friction disturbance 702 does not change direction relative to the velocity of the gimbal or shaft 404. Thus, consistent with the LOS offset shown in FIG. 6F, the zero crossing 704 of the combined friction disturbance 702 is now offset away from the zero velocity 706 of the shaft 404 as illustrated in FIG. 7.

In an alternate implementation, the inner and outer bearings 408 and 410 may be replaced with two slip ring assembles configured in tandem to rotate a gimbal shaft relative to a housing or support structure with a common sleeve or equivalent part coupling the two slip ring assemblies in tandem. The sleeve or part of the total assembly that is common to both slip rings is driven with a small motor, like the gear motor 444, to compensate for the friction of the slip ring driving the gimbal shaft. In another implementation, a hydraulic rotary joint may be designed in a similar way using two rotary joints joined together with a motor driving the common part of the rotary joints to compensate for the friction of the rotary joint driving the gimbal shaft.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the components of the described implementation of the servo controller 454 (e.g., the summer 532, the compensator 536, the rate loop gain controller 538 and the power amplifier 540) may be implemented in hardware or a combination of software and hardware. For example, summer 532, the compensator 536, the loop gain controller 538, and the power amplifier 540 may be wholly or partly incorporated into a logic circuit, such as a custom application specific integrated circuit (ASIC) or a programmable logic device such as a PLA or FPGA. Alternatively, the servo controller 454 may include a central processor (CPU) and memory that hosts component program modules associated with, for example, the compensator 536 and the loop gain controller 538, which are run by the CPU.

Accordingly, while various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A bearing assembly suitable for use in a gimbal servo system, comprising:
a shaft having an end adapted to be coupled to a payload;
a sleeve disposed over the shaft;
an inner bearing rotatingly coupled to the shaft and to the sleeve such that the sleeve is adapted to rotate about the shaft;
an outer housing disposed over the sleeve;
an outer bearing rotatingly coupled to the sleeve and the outer housing such that the sleeve is adapted to rotate about the shaft relative to the housing;
a first motor operatively configured to rotate the shaft relative to the outer housing; and
a second motor operatively configured to rotate the sleeve about the shaft.

2. A bearing assembly as set forth in claim 1, wherein the second motor rotates the sleeve in a predetermined direction at a predetermined velocity having a sign corresponding to the predetermined direction.

3. A bearing assembly as set forth in claim 2, wherein:
the inner bearing imparts a friction disturbance on the shaft when the shaft is rotated, the friction disturbance corresponds to a bearing velocity having a sign corresponding to a direction of shaft rotation, and
the predetermined velocity of the sleeve is set such that a sum of the predetermined velocity and the bearing velocity remains positive regardless of the direction of the shaft rotation.

4. A bearing assembly as set forth in claim 3, wherein the predetermined velocity is set such that the sum of the predetermined velocity and the bearing velocity is within the range of 0 to 7 radians per second.

5. A bearing assembly as set forth in claim 3, wherein the second motor is adapted to continuously rotate the sleeve in the predetermined direction while the first motor is operating.

6. A bearing assembly suitable for use in a gimbal servo system, comprising:
a shaft having an end adapted to be coupled to a payload;
an inner bearing rotatingly coupled to the shaft, the inner bearing having an outer race member and an inner race member, the inner race member of the inner bearing being coupled to the shaft;
a sleeve disposed over the shaft, the sleeve having an inner surface and an outer surface, the outer race member of the inner bearing being coupled to the inner surface of the sleeve;
an outer bearing having an external race member and an internal race member, the internal race member being coupled to the outer surface of the sleeve, the outer race member, the internal race member, and the sleeve collectively defining a middle race member;
an outer housing disposed over the sleeve and coupled to the external race member of the outer bearing,
a first motor operatively configured to rotate the shaft relative to the outer housing; and
a second motor operatively configured to rotate the middle race member about the shaft.

7. A bearing assembly as set forth in claim 6, wherein the second motor rotates the middle race member in a predetermined direction at a predetermined velocity having a sign corresponding to the predetermined direction.

8. A bearing assembly as set forth in claim 7, wherein:
the inner bearing imparts a friction disturbance on the shaft when the shaft is rotated, the friction disturbance corresponds to a bearing velocity having a sign corresponding to a direction of shaft rotation, and
the predetermined velocity is set such that a sum of the predetermined velocity and the bearing velocity remains positive regardless of the direction of the shaft rotation.

9. A bearing assembly as set forth in claim 8, wherein the predetermined velocity is set such that the sum of the predetermined velocity and the bearing velocity is within the range of 0 to 7 radians per second.

10. A bearing assembly as set forth in claim 8, wherein the second motor is adapted to continuously rotate the middle race member in the predetermined direction while the first motor is operating.

11. A bearing assembly as set forth in claim 6, further comprising a ring gear operatively coupled to the sleeve such that the sleeve rotates in accordance with rotation of the ring gear, wherein the second motor is a gear motor operatively configured to drive the ring gear.

12. A bearing assembly as set forth in claim 11, further comprising a spur gear operatively coupling the ring gear to the gear motor.

13. A bearing assembly as set forth in claim 6, wherein the inner bearing includes a ball bearing disposed between the inner race member and the outer race member.

14. A bearing assembly as set forth in claim 6, wherein the outer bearing includes a ball bearing disposed between the internal race member and the external race member.

15. A bearing assembly as set forth in claim 6, wherein the first motor includes a stator attached to the housing and a rotor attached to the shaft.
